(19) United States
(12) Patent Application Publication
(10) Pub. No.: US 2025/0173285 A1
(43) Pub. Date: May 29, 2025

(54) SERVER, COMMUNICATION SYSTEM, AND METHOD OF TRANSMITTING TARGET DATA TO DEVICE

(71) Applicant: BROTHER KOGYO KABUSHIKI KAISHA, Nagoya (JP)

(72) Inventors: Yutaka TAKIJIRI, Nagoya (JP); Tomofumi NAKAYAMA, Tokoname (JP); Hiroki SUMI, Nagoya (JP)

(21) Appl. No.: 18/922,626

(22) Filed: Oct. 22, 2024

(30) Foreign Application Priority Data
Nov. 29, 2023 (JP) 2023-201493

(51) Int. Cl. G06F 13/20

(52) U.S. Cl. CPC G06F 13/20; G06F 2213/40

(57) ABSTRACT

A server includes a memory configured to store target data in association with status information indicating a plurality of states including a first state indicating that target data is to be transmitted to a device and a second state. A controller transmits the target data to the device by a first communication method that is a push-type communication method, after transmitting the target data to the device, receives a particular notification relating to the target data from the device, in response to receiving the particular notification, updates the status information of the target data from information indicating the first state to information indicating the second state, receives a particular request from the device, and in response to receiving the particular request, transmits, to the device, the target data associated with the status information indicating the first state by a second communication method that is a pull-type communication method.

### REFERENCE TO RELATED APPLICATIONS

This application claims priority from Japanese Patent Application No. 2023-201493 filed on Nov. 29, 2023. The entire content of the priority application is incorporated herein by reference.

### BACKGROUND ART

A protocol for performing push-type communication called Message Queuing Telemetry Transport (hereinafter also referred to as MQTT) is known.

### SUMMARY

In a communication system, data is collected from a device by transmitting a data transmission instruction to the device using the MQTT. In such push-type communication, a transmission-side apparatus transmits information to the device at an arbitrary timing with a delay smaller than that in pull-type communication.

However, in the push-type communication, for example, depending on a protocol to be used, it may not be possible to accurately grasp whether the device has acquired information, and there is a possibility that the reliability of delivery of data to the device is not sufficient.

In view of the foregoing, the present specification discloses a technique for improving the reliability of delivery of data to a device while using push-type communication for communication with the device.

According to one aspect, this specification discloses a server. The server includes a communication interface, a memory, and a controller. The memory is configured to store target data in association with status information. The status information indicates a plurality of states including a first state and a second state. The first state indicates that the target data is to be transmitted to a device of a transmission destination. The second state is different from the first state. The controller is configured to transmit, via the communication interface, the target data to the device by a first communication method. The first communication method is a push-type communication method. Thus, the server transmits the target data to the device by the first communication method. The controller is configured to, after transmitting the target data to the device, receive, via the communication interface, a particular notification relating to the target data from the device. Thus, the server receives the particular notification. The controller is configured to, in response to receiving the particular notification, update the status information of the target data from information indicating the first state to information indicating the second state. Thus, the server updates the status information of the target data. The controller is configured to, receive, via the communication interface, a particular request from the device. Thus, the server receives the particular request. The controller is configured to, in response to receiving the particular request, transmit, to the device, the target data associated with the status information indicating the first state by a second communication method. The second communication method is a pull-type communication method. Thus, the server transmits such target data by the second communication method.

According to the above configuration, in a case where the particular notification is received from the device after the target data is transmitted to the device using the first transmission portion that transmits the target data in accordance with the push-type communication method, the status information of the target data is updated from the information indicating the first state to the information indicating the second state. In a case where a particular request is received from the device, the target data associated with the status information indicating the first state is transmitted to the device by using the second transmission portion that transmits the target data in accordance with the pull-type communication method. As a result, for example, in a case where the transmission of the target data by the push-type communication method fails and the particular notification from the device is not received, the target data is transmitted to the device by the pull-type communication method in response to the particular request from the device. This improves the reliability of the transmission of the target data to the device while using the push-type communication for the communication with the device.

The technique disclosed in the present specification may be implemented in various modes, and may be implemented in the form of, for example, a method for transmitting target data to a device, a communication system including a server and a device, a computer program for implementing the functions of the server, the method, the communication system, or the device, a storage medium in which the computer program is recorded, and so on.

### BRIEF DESCRIPTION OF DRAWINGS

FIG. 1 is a block diagram showing a configuration of a system 1000.

FIG. 2 is an explanatory diagram of a management database DBm.

FIG. 3 is a first sequence diagram showing an operation of the system 1000.

FIG. 4 is a second sequence diagram showing the operation of the system 1000.

FIG. 5 is a third sequence diagram showing the operation of the system 1000.

FIG. 6 is a fourth sequence diagram showing the operation of the system 1000.

FIG. 7 is a flowchart of a process when a command transmission instruction is received.

FIG. 8 is a fifth sequence diagram showing the operation of the system 1000.

### DESCRIPTION

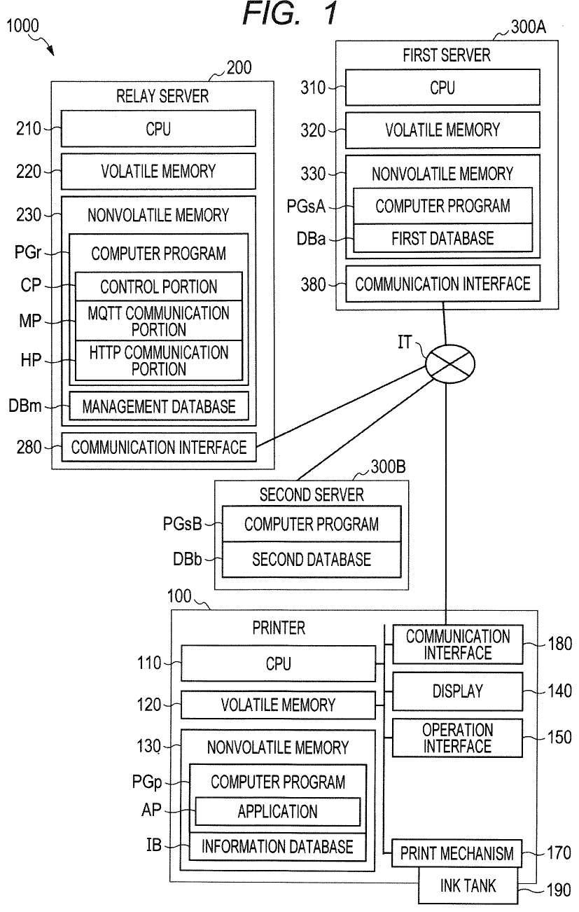

FIG. 1 is a block diagram showing a configuration of a system 1000. The system 1000 includes a printer 100, a first server 300A, a second server 300B, and a relay server 200.

The printer 100 is a device that performs printing by consuming ink as a printing material. The printer 100 includes a CPU 110 as a controller of the printer 100, a volatile memory 120 such as a DRAM, and a nonvolatile memory 130 such as a hard disk or a flash memory. The printer 100 further includes a display 140 such as a liquid crystal display for displaying an image, an operation interface 150 such as a button or a touch panel for acquiring an operation by a user, a print mechanism (print engine) 170, and a communication interface (IF) 180.

The communication interface 180 is an interface for connecting to Internet IT, that is, a wired interface compliant with Ethernet or a wireless interface compliant with the Wi-Fi standard, for example. The “Wi-Fi is a registered trademark of Wi-Fi Alliance.

The CPU 110 is a computing device (processor) that performs data processing. The volatile memory 120 provides a buffer area for temporarily storing various intermediate data generated when the CPU 110 performs processing. The nonvolatile memory 130 stores a computer program PGp for controlling the printer 100 and an information database IB in which various kinds of information described later are recorded.

In the present embodiment, the computer program PGp is provided by being stored in advance in the nonvolatile memory 130 at the time of manufacturing the printer 100. Instead of this, the computer program PGp may be provided in a form of being downloaded from a server connected via the Internet IT or in a form of being recorded in a storage medium such as a CD-ROM or a USB memory.

The CPU 110 executes various processes for controlling the printer 100 by executing the computer program PGp. For example, the CPU 110 executes as an application AP (application program) that realizes a printing process and a service-related process. The printing process is a process of controlling the print mechanism 170 to cause the print mechanism 170 to print an image. The service-related process is a process for providing, to the user, a first print service and a second print service described later in cooperation with the first server 300A, the second server 300B, and the relay server 200. These print services will be described later.

The information database IB stores setting information of the printer 100 and information necessary for receiving a print service using the printer 100, that is, destination information and authentication information for accessing the first server 300A, for example. Details of the information database IB are omitted.

The print mechanism 170 performs printing in accordance with the control of the CPU 110. The print mechanism 170 of the present embodiment is an inkjet print mechanism that prints an image on a recording medium using a plurality of types of ink (for example, four types of ink of cyan, magenta, yellow, and black) stored in ink tanks 190 as color materials. Alternatively, the print mechanism 170 may be an electrophotographic print mechanism that prints an image on a recording medium using toner contained in a toner cartridge as a color material.

The first server 300A, the second server 300B, and the relay server 200 are, for example, computers operated by a business operator that provides a print service (for example, a business operator that manufactures or sells the printer 100), and are cloud servers, for example.

The first server 300A includes a CPU 310 as a controller of the first server 300A, a volatile memory 320 such as a DRAM, a nonvolatile memory 330 such as a hard disk or a flash memory, and a communication interface 380. The communication interface 380 is, for example, a wired interface compliant with Ethernet.

The CPU 310 is a computing device (processor) that performs data processing. The volatile memory 320 provides a buffer area for temporarily storing various intermediate data generated when the CPU 310 performs processing. The nonvolatile memory 330 stores a computer program PGsA and a first database DBa.

The computer program PGsA is provided in a form of being uploaded by a business operator who operates the print service, for example. The CPU 310 of the first server 300A executes the computer program PGsA to execute processing related to the first print service.

In the present embodiment, the first print service provided by the first server 300A is a remote print service. For example, the remote print service is a service of generating a print instruction (also referred to as a print job) using an image file stored in a server by a user or an image file transmitted from a mobile terminal (not shown) of the user, and transmitting the print instruction to the printer, thereby causing the printer to perform printing.

The first database DBa stores various kinds of information necessary for the first print service. For example, the first database DBa includes information (account information and payment information) of a user who uses the first print service and information (a device ID and model information of a printer) of the printer used by the user. Details of the first database DBa are omitted.

Although not shown, the second server 300B includes a controller (310, 320, 330, and 380), similarly to the first server 300A. However, the nonvolatile memory 330 of the second server 300B stores a computer program PGsB different from the computer program PGsA and a second database DBb different from the first database DBa.

The computer program PGsB is provided in a form of being uploaded by a business operator who operates the print service, for example. The CPU 310 of the second server 300B executes the computer program PGsB to execute processing related to the second print service.

In the present embodiment, the second print service provided by the second server 300B is a printing material management service. The printing material management service is a service for managing the remaining amount of a printing material such as ink in a printer and delivering the printing material to a user in accordance with consumption of the printing material.

The second database DBb stores various kinds of information necessary for the second print service. For example, the second database DBb includes information of a user who uses the second print service (account information and payment information) and information of the printer used by the user (a device ID and model information of a printer). The second database DBb further includes remaining ink amount information and print history information of each printer that are collected from the printer. Details of the second database DBb are omitted.

Although one printer 100 is shown in FIG. 1, the first server 300A and the second server 300B provide a print service to a large number of users by using a large number of printers. In the following, various processes for one printer 100 will be described, but these processes are performed independently for each of a plurality of printers (hereinafter, also referred to as target printers) used for a service. For example, the printer 100 is the target printer.

The relay server 200 includes a CPU 210 as a controller, a volatile memory 220, a nonvolatile memory 230, and a communication interface 280, similarly to the servers 300A and 300B. The volatile memory 220 provides a buffer area for temporarily storing various intermediate data generated when the CPU 210 performs processing. The nonvolatile memory 230 stores a computer program PGr and a management database DBm.

The communication interface 280 is, for example, a wired interface compliant with Ethernet. Since the communication interface 280 is connected to the Internet IT, the relay server 200 communicates with the servers 300A and 300B via the Internet IT. When the printer 100 is connected to the Internet IT, the relay server 200 communicates with the printer 100 via the Internet IT.

The computer program PGr is provided in a form of being uploaded by a business operator who operates the print service, for example, similarly to the computer programs PGsA and PGsB. The CPU of the relay server 200 executes the computer program PGr to realize the functions as the relay server 200.

Specifically, the relay server 200 (210) functions as a control portion CP, an MQTT communication portion MP, and an HTTP communication portion HP by executing the computer program PGr. As will be described in detail later, the control portion CP controls the MQTT communication portion MP and the HTTP communication portion HP to relay communication between the server 300A, 300B and the printer 100.

The MQTT communication portion MP performs communication with the printer 100 in accordance with a protocol called MQTT (Message Queuing Telemetry Transport). Specifically, in the communication between the MQTT communication portion MP and the printer 100, the MQTT communication portion MP functions as an MQTT broker, and the printer 100 functions as an MQTT client. In the present embodiment, the printer 100 maintains a communication connection with the MQTT communication portion MP and subscribes to a topic addressed to the printer 100. The connection maintained with the MQTT communication portion MP is, for example, a connection based on the TCP (Transmission Control Protocol)/IP (Internet Protocol). The topic addressed to the printer 100 is, for example, a message (data to be transmitted) having a topic name including the device ID of the printer 100. When the control portion CP publishes the topic addressed to the printer 100 to the MQTT communication portion MP, the MQTT communication portion MP transmits the topic addressed to the printer 100 to the device (that is, the printer 100) that subscribes to the topic.

In this way, in a case where the printer 100 subscribes to the topic addressed to the printer 100, the MQTT communication portion MP transmits data to the printer 100 as a topic at arbitrary timing. Thus, it can be said that the communication with the printer 100 by the MQTT communication portion MP is push-type communication.

When the printer 100 is not powered on, for example, the printer 100 cannot subscribe to the topic addressed to the printer 100. In a case where the printer 100 does not subscribe to the topic addressed to the printer 100, even if the control portion CP publishes the topic addressed to the printer 100 to the MQTT communication portion MP, the MQTT communication portion MP does not transmit the topic to the printer 100.

The MQTT communication portion MP does not notify the control portion CP about the transmission result of the topic, regardless of whether the topic is transmitted to the printer 100. Thus, the control portion CP does not know whether the published topic (data to be transmitted) has actually reached the printer 100.

The HTTP communication portion HP performs communication with the printer 100 in accordance with a protocol called HTTP (Hypertext Transfer Protocol). Specifically, in the communication between the HTTP communication portion HP and the printer 100, the HTTP communication portion HP functions as an HTTP server, and the printer 100 functions as an HTTP client. In the present embodiment, when the printer 100 transmits an HTTP request to the relay server 200 (the HTTP communication portion HP), the HTTP communication portion HP transmits, to the printer 100, data to be transmitted as a response (HTTP response) to the HTTP request.

In this way, in response to receiving a request (HTTP request) from the printer 100, the HTTP communication portion HP transmits data to the printer 100 as a response (HTTP response) to the request. Thus, it can be said that the communication with the printer 100 by the HTTP communication portion HP is pull-type communication.

In the communication by the HTTP communication portion HP, since data cannot be transmitted to the printer 100 at an arbitrary timing, a delay is likely to occur. In order to reduce the delay, the printer 100 needs to continuously transmit the HTTP request to the relay server 200 at short intervals, and the load on the printer 100 and the relay server 200 is likely to increase. In the communication by the HTTP communication portion HP, since data is transmitted in response to the request of the printer 100, the data is transmitted when the printer 100 is in a state ready to receive data, and thus the data is highly likely to be reliably delivered to the printer 100.

In the present embodiment, as will be described in detail later, the relay server 200 relays communication between the server 300A, 300B and the printer 100 by appropriately using both communication by the MQTT communication portion MP and communication by the HTTP communication portion HP.

For example, the first server 300A transmits, to the printer 100, a print instruction (also referred to as a print job) to be transmitted to the printer 100 via the relay server 200 in order to provide a remote print service. The first server 300A receives information indicating an execution result of the print job from the printer 100 via the relay server 200.

In order to provide a printing material management service, the second server 300B transmits, for example, a transmission instruction of the remaining amount information of a printing material of the printer 100 or a transmission instruction of history information such as a printing history or a failure history of the printer 100, to the printer 100 via the relay server 200. The second server 300B receives information indicating an execution result of the transmission instruction, such as information indicating the remaining amount of the printing material and information indicating the printing history and the failure history of the printer 100, from the printer 100 via the relay server 200.

Hereinafter, information (specifically, a print instruction or a transmission instruction) to be transmitted from the server 300A, 300B to the printer 100 is also referred to as a command. Information to be transmitted from the printer 100 to the server 300A, 300B, that is, information indicating an execution result of processing executed based on a command (various instructions) is also referred to as execution result information. Specifically, the information indicating the execution result is a print result, remaining amount information, or history information.

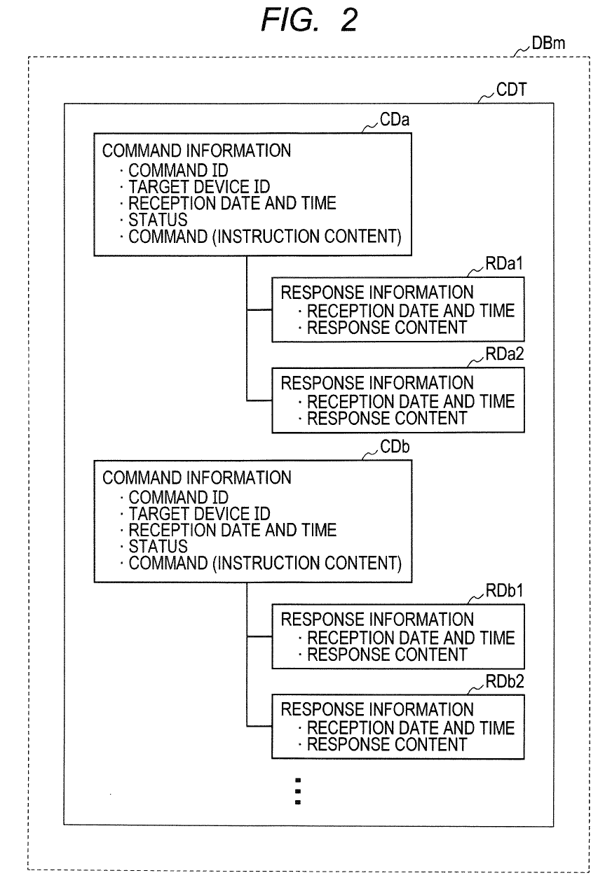

FIG. 2 is an explanatory diagram of the management database DBm. The management database DBm stores a command information table CDT for storing information on commands received from the server 300A, 300B, that is, information on commands requested to be relayed by the server 300A, 300B (hereinafter, also referred to as command information). The command information table CDT is prepared for each device of the transmission destination, and FIG. 2 shows the command information table CDT for storing command information relating to commands to be transmitted to the printer 100.

The command information table CDT stores a plurality of command information CDa and CDb. Each command information includes information indicating a command ID, a target device ID, a reception date and time of the command, a status of the command, and the command (the content instructed by the command).

The command ID is an identifier for identifying a command. The target device ID is a device ID of a device (for example, the printer 100) of the transmission destination of the command. The device ID is an identifier for identifying the device. The reception date and time of the command is the date and time when the relay server 200 receives the command from the server 300A, 300B.

In the present embodiment, the status of the command indicates one of three states, that is, accepted, delivered, and cancelled. The accepted state is a state in which the command transmission instruction has been accepted, that is, a state in which the command has been acquired from the server 300A, 300B but has not been acquired by the device of the transmission destination, and the command has not been canceled by the server 300A, 300B. The delivered state is a state in which the command is acquired by the device of the transmission destination. The cancelled state is a state in which the command is acquired from the server 300A, 300B but is not acquired by the device of the transmission destination, and the command has been cancelled by the server 300A, 300B.

Since a command in the accepted state should be transmitted to the device of the transmission destination, it can be said that the accepted state is a state indicating that the command should be transmitted to the device of the transmission destination. Since the command in the delivered or cancelled state does not need to be transmitted to the device of the transmission destination, it can be said that the delivered or cancelled state is a state indicating that the command does not need to be transmitted to the device of the transmission destination.

Here, a phrase that the command is acquired means that the command is acquired by an application that should process the command in the device of the transmission destination of the command. For example, a phrase that the command is acquired by the relay server 200 means that the command is acquired by the control portion CP which is an application that should process the command in the relay server 200. A phrase that the command is acquired by the printer 100 means that the command is acquired by the application AP which is an application that should process the command in the printer 100. For example, in a case where the command is received by the communication interface 180 of the printer 100 and is temporarily stored in a reception buffer but the application AP does not acquire the command from the reception buffer for some reason (for example, an error or a high load), the command is not acquired by the printer 100. Further, in a case where the printer 100 is in the online state and the relay server 200 attempts to transmit a command to the printer 100, but the entire command does not reach the printer 100 due to network congestion and so on, the command is not acquired by the printer 100.

The command is data indicating an instruction content, and is information necessary for a device (for example, the printer 100) to execute processing based on the command. For example, in a case where the command is a print instruction, the command may include information indicating that the command is a print instruction, information indicating the number of sheets to be printed and print settings, and an image file indicating a print image.

The command information table CDT stores response information transmitted from a device that has received a command, in association with the command information CDa, CDb. In the example of FIG. 2, two response information RDa1 and RDa2 are stored in association with the command information CDa, and two response information RDb1 and RDb2 are stored in association with the command information CDb.

Each response information includes information indicating reception date and time of the response and a response content. The information indicating the reception date and time is the date and time when the relay server 200 receives the response from the device. For example, in a case where the response is an acquisition notification of a command, the response content includes information indicating that the command has been acquired. For example, in a case where the response is a command execution result notification, the response content includes execution result information indicating the result of executing the command.

The operation of the system 1000 will be described with a focus on a relay process by the relay server 200. The relay process includes a process in which the relay server 200 relays a command (for example, a print instruction) transmitted from the first server 300A and transmits the command to the printer 100. The relay process includes a process in which the relay server 200 relays a response (an acquisition notification or an execution result notification) transmitted from the printer 100 and transmits the response to the first server 300A.

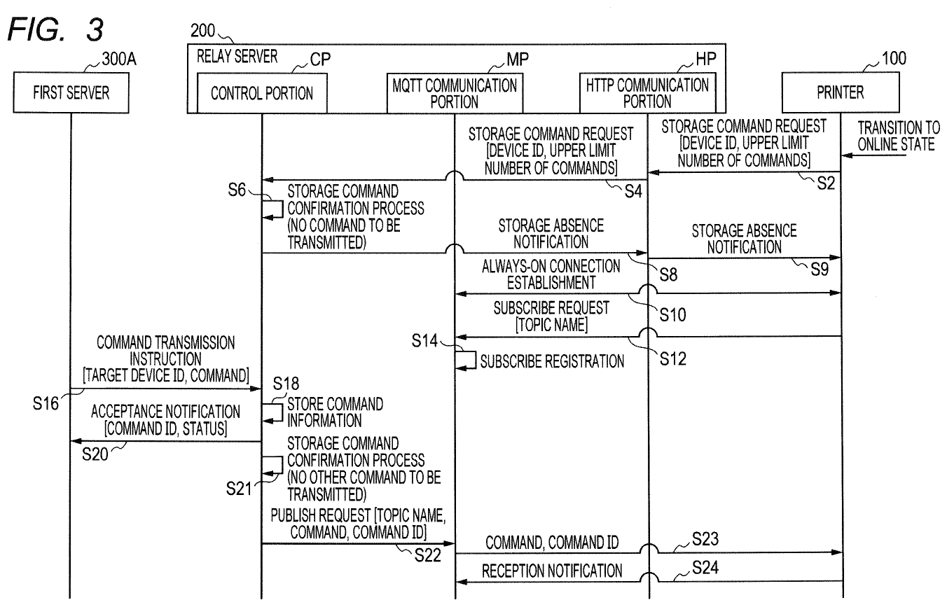

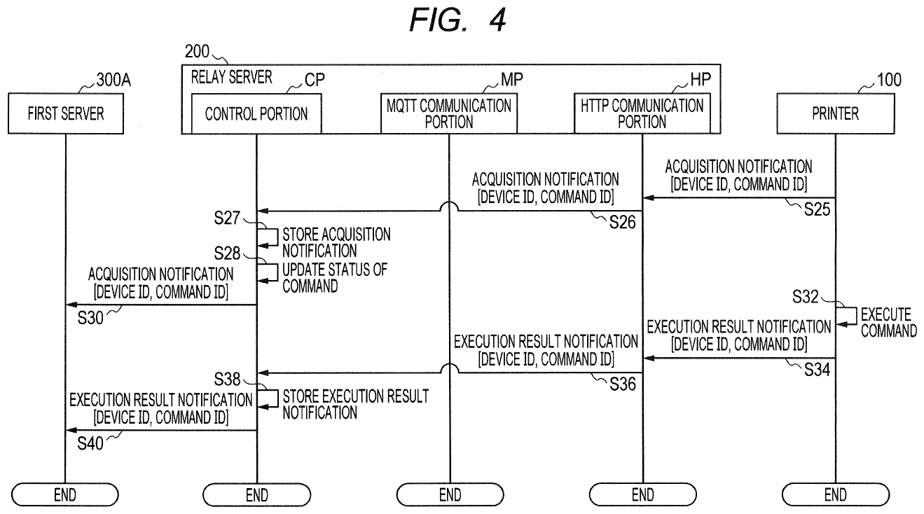

FIGS. 3 to 6 are sequence diagrams showing the operation of the system 1000. FIGS. 3 and 4 show an example of the operation in a case where the printer 100 subscribes to a command when the relay server 200 accepts a command. The time when the relay server 200 accepts a command means the time when the first server 300A transmits a command transmission instruction to the relay server 200 and the relay server 200 acquires the command transmission instruction. The printer 100 subscribing to a command means that the printer 100, as an MQTT client, is in a state of subscribing to a topic addressed to the printer 100. In order for the printer 100 to subscribe to a command, it is necessary that the printer 100 is connected to the Internet IT and is in a state in which the printer 100 is ready to communicate with the relay server 200 (also called an online state). A state in which the printer 100 is not in an online state, that is, a state in which the printer 100 cannot communicate with the relay server 200, is also called an offline state. The printer 100 is in an offline state when the printer 100 is powered off or when a problem occurs in the network to which the printer 100 is connected.

For ease of understanding, the printer 100 will first be described from the point in time when the printer 100 transitions from an offline state to an online state. For example, the printer 100 transitions from an offline state to an online state when the printer 100 is powered on, when the printer 100 is connected to a network, or when a problem in the network to which the printer 100 is connected is resolved. When the printer 100 transitions from an offline state to an online state, the printer 100 (the CPU 110 functioning as the application AP) transmits a storage command request to the relay server 200 in S2. Information on the relay server 200 of the transmission destination (for example, the URL and IP address of the relay server 200) is recorded in advance in the information database IB.

The storage command request is an HTTP request that requests the relay server 200 to transmit commands to the printer 100 in a case where the commands are stored in the relay server 200. The storage command request includes the device ID of the printer 100 and information indicating the upper limit number of commands. The upper limit number of commands is the number (maximum number) of commands that are receivable by the printer 100 in one response (HTTP response).

Since the storage command request is transmitted as an HTTP request, the storage command request is received by the communication interface 280 of the relay server 200 and acquired by the HTTP communication portion HP of the relay server 200.

When the HTTP communication portion HP acquires the storage command request, in S4, the HTTP communication portion HP passes the storage command request to the control portion CP of the relay server 200. When the control portion CP receives the storage command request, in S6, the control portion CP executes a storage command confirmation process to confirm whether a command to be transmitted to the printer 100 is stored in the relay server 200.

Specifically, the control portion CP determines whether command information including information indicating that the status of the command is “accepted” (hereinafter, also referred to as command information in an accepted state) is stored in the command information table CDT (FIG. 2) for storing command information related to the command to be transmitted. If the command information in the accepted state is stored in the command information table CDT, the control portion CP determines that the command to be transmitted is stored. If the command information in the accepted state is not stored in the command information table CDT, the control portion CP determines that the command to be transmitted is not stored. In S6 of FIG. 3, it is assumed that the command information in the accepted state is not stored in the command information table CDT. In this case, in S6, the control portion CP determines that the command to be transmitted is not stored.

When it is determined that the command to be transmitted to the printer 100 is not stored, in S8 the control portion CP passes a storage absence notification to the HTTP communication portion HP as response data. The storage absence notification indicates that a command to be transmitted is not stored.

When the HTTP communication portion HP receives the storage absence notification, in S9, the HTTP communication portion HP transmits the storage absence notification to the printer 100 as a response to the storage command request. The response transmitted from the HTTP communication portion HP to the printer 100 is an HTTP response.

When the printer 100 receives the storage absence notification, in S10, the printer 100 and the MQTT communication portion MP of the relay server 200 establish an always-on connection. This always-on connection is established between the printer 100 as an MQTT client and the MQTT communication portion MP as an MQTT broker. This always-on connection is maintained when the printer 100 is in the online state.

When the printer 100 establishes an always-on connection, in S12, the printer 100 transmits a subscribe request to the MQTT communication portion MP. The subscribe request requests subscribing to a topic addressed to the printer 100. The subscribe request includes information indicating the name of the topic addressed to the printer 100 (topic name).

When the MQTT communication portion MP receives the subscribe request, in S14, the MQTT communication portion MP executes a subscribe registration. The subscribe registration is a process of registering a topic having the topic name included in the subscribe request as a topic to be transmitted to the printer 100. In this way, the printer 100 is put into a state in which the printer 100 subscribes to a command addressed to the printer 100 (in other words, a topic addressed to the printer 100). Hereinafter, this state will be also referred to as a subscribed state.

The MQTT communication portion MP does not notify the control portion CP about a device for which a subscribe registration has been performed. Thus, the control portion CP does not recognize whether the printer 100 is in a subscribed state.

When the printer 100 is in a subscribed state, the first server 300A transmits a command transmission instruction to the relay server 200 (S16 in FIG. 3). The command transmission instruction instructs the relay server 200 to transmit a command to the device. The command transmission instruction includes a target device ID and a command to be transmitted. The target device ID is an identifier indicating the device to which the command is to be transmitted. The communication between the first server 300A and the relay server 200 is performed according to a known communication protocol (for example, HTTP or a dedicated protocol).

When the relay server 200 receives the command transmission instruction, in S18, the control portion CP of the relay server 200 stores command information (FIG. 2) related to the command included in the command transmission instruction. Specifically, the control portion CP generates a command ID to be assigned to the command included in the command transmission instruction. The control portion CP generates information indicating the current date and time as information indicating the reception date and time of the command. The control portion CP generates information indicating “accepted” as status information indicating the current status of the command. The control portion CP stores the command information including the command and target device ID included in the command transmission instruction and the generated information (command ID, reception date and time, status) in the command information table CDT (FIG. 2) of the management database DBm. In the example of FIG. 3, it is assumed that the first command information CDa is stored in the command information table CDT in FIG. 2 at this point.

The information indicating the reception date and time of the command can also be said to be information indicating the storage date and time when the command information is stored in the command information table CDT. When a plurality of command information is stored in the command information table CDT, the storage order of the plurality of command information is identified by comparing the information indicating the reception date and time of the command. Thus, the information indicating the reception date and time of the command can be said to be information for specifying the storage order of a plurality of command information, or information indicating the reception order of the transmission instructions of a plurality of commands.

In S20, the control portion CP transmits an acceptance notification indicating that the command transmission instruction has been accepted to the first server 300A. The acceptance notification includes the command ID included in the command information stored in S18 and the status information of the command.

In S21, the control portion CP executes a storage command confirmation process. As described in S6, the storage command confirmation process is a process of confirming whether command information in the accepted state is stored in the command information table CDT. Here, in a case where another command information in the accepted state is stored in the command information table CDT in addition to the command information related to the command based on the command transmission instruction received in S16, it is determined that another command to be transmitted to the printer 100 is stored. In S21, it is determined that no other command to be transmitted is stored.

When it is determined that no other command to be transmitted is stored, the control portion CP uses the MQTT communication portion MP to transmit a command to the printer 100. Specifically, in S22, the control portion CP passes a publish request to the MQTT communication portion MP. The publish request requests that designated data be transmitted to a device that subscribes to a designated topic. The publish request includes a topic name for designating the topic and data to be transmitted. In the example of FIG. 3, the topic name included in the publish request is the name of the topic addressed to the printer 100. The data included in the publish request includes the command included in the command transmission instruction received in S16 and the command ID of the command.

When the MQTT communication portion MP receives the publish request, the MQTT communication portion MP attempts to transmit the command and command ID included in the publish request to a device that subscribes to the topic designated by the topic name included in the publish request. At this point, the printer 100 is in a subscribed state, and the MQTT communication portion MP stores that the printer 100 subscribes to the topic addressed to the printer 100 (S14 in FIG. 3). Thus, in S23, the MQTT communication portion MP transmits the command and the command ID to the printer 100. When the printer 100 receives the command and the command ID, in S24, the printer 100 transmits a reception notification to the MQTT communication portion MP of the relay server 200. That is, the printer 100 transmits a reception notification as a response to the command in accordance with the MQTT protocol. This reception notification is a PUBACK defined in the MQTT protocol.

In the example of FIG. 3, the command and the command ID are received by the printer 100 and are properly acquired by the application AP of the printer 100. Due to the specifications of MQTT, the MQTT communication portion MP does not notify the control portion CP that the command has been transmitted to the printer 100. For example, the MQTT communication portion MP does not pass the reception notification received in S24 to the control portion CP. Thus, the control portion CP cannot recognize that the command has been acquired by the printer 100 by communicating with the MQTT communication portion MP. Thus, at this point, the control portion CP cannot update the status information of the command of the processing target from “accepted” to “delivered”.

In S25 of FIG. 4, the printer 100 transmits, to the relay server 200, an acquisition notification indicating that the command has been acquired, in addition to the reception notification described above. The acquisition notification includes the command ID of the received command and the device ID of the printer 100. The acquisition notification is transmitted to the relay server 200 as an HTTP request. That is, the acquisition notification is transmitted in accordance with HTTP, which is a protocol different from MQTT. Thus, the acquisition notification is received by the HTTP communication portion HP of the relay server 200.

When the HTTP communication portion HP receives the acquisition notification, in S26 the HTTP communication portion HP passes the acquisition notification to the control portion CP. In this way, although the control portion CP does not receive the reception notification (PUBACK) transmitted from the printer 100 in accordance with MQTT in S23, the control portion CP receives the acquisition notification transmitted from the printer 100 in accordance with HTTP in S25. Thus, at this point, the control portion CP recognizes that the command has been acquired by the printer 100.

When the control portion CP receives the acquisition notification, in S27 the control portion CP stores the acquisition notification. Specifically, the control portion CP generates information indicating the current date and time as information indicating the reception date and time of the acquisition notification. The control portion CP generates response information including the acquisition notification and information on the reception date and time of the acquisition notification. The control portion CP identifies the command of the processing target by referring to the command ID included in the acquisition notification. The control portion CP stores the response information in the command information table CDT (FIG. 2) of the management database DBm in association with the command information of the command of the processing target. For example, it is assumed that the command information of the command of the processing target is the command information CDa in FIG. 2. In this step, the first response information RDa1 is stored in the command information table CDT in association with the command information CDa.

In S28, the control portion CP updates the status information of the command of the processing target from “accepted” to “delivered”. For example, in the command information table CDT in FIG. 2, the status information included in the command information CDa is changed from information indicating “accepted” to information indicating “delivered”. In this way, when the control portion CP receives the first response to the command of the processing target, the control portion CP updates the status information of the command of the processing target from “accepted” to “delivered”. The control portion CP may receive a second response (for example, an execution result notification to be described later) to the command of the processing target, but does not update the status information when the control portion CP receives the second or subsequent responses.

In S30, the control portion CP transmits the acquisition notification received in S26 to the first server 300A. As a result, the first server 300A recognizes that the command has been transmitted to the printer 100 and acquired by the printer 100, based on the command transmission instruction transmitted in S16.

After the printer 100 transmits the acquisition notification in S25, in S32 the printer 100 executes the command acquired in S23 of FIG. 3. For example, in a case where the command is a print instruction, the printer 100 executes printing using the image file designated in the command.

In S34, the printer 100 transmits, to the relay server 200, an execution result notification indicating the execution result of the command. The execution result notification includes the command ID of the executed command and the device ID of the printer 100, similar to the acquisition notification described above. The execution result notification is transmitted to the relay server 200 as an HTTP request, similar to the acquisition notification. Thus, the execution result notification is received by the HTTP communication portion HP of the relay server 200.

When the HTTP communication portion HP receives the execution result notification, in S36 the HTTP communication portion HP passes the execution result notification to the control portion CP. When the control portion CP receives the execution result notification, in S38 the control portion CP stores the execution result notification. Specifically, the control portion CP generates information indicating the current date and time as information indicating the reception date and time of the execution result notification. The control portion CP generates response information including the execution result notification and information on the reception date and time of the execution result notification. The control portion CP identifies the command of the processing target by referring to the command ID included in the execution result notification. The control portion CP stores the response information in the command information table CDT (FIG. 2) of the management database DBm in association with the command information of the command of the processing target. For example, it is assumed that the command information of the command of the processing target is the command information CDa in FIG. 2. In this step, the second response information RDa2 is stored in association with the command information CDa in the command information table CDT.

In S40, the control portion CP transmits the execution result notification received in S36 to the first server 300A. In this way, the first server 300A recognizes the execution result of the command transmitted based on the command transmission instruction transmitted in S16. For example, the first server 300A recognizes that printing has been performed by the printer 100 based on the print instruction transmitted as the command.

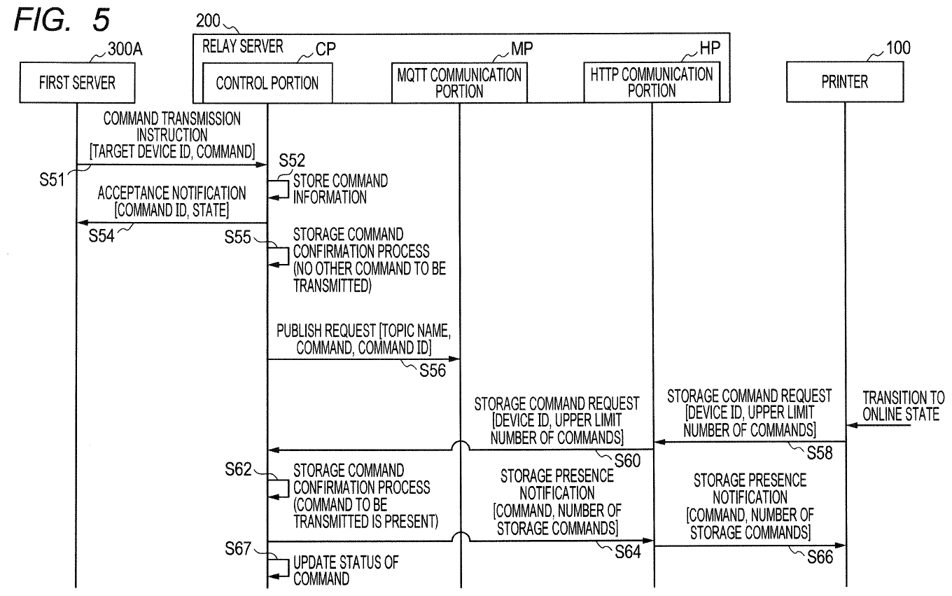

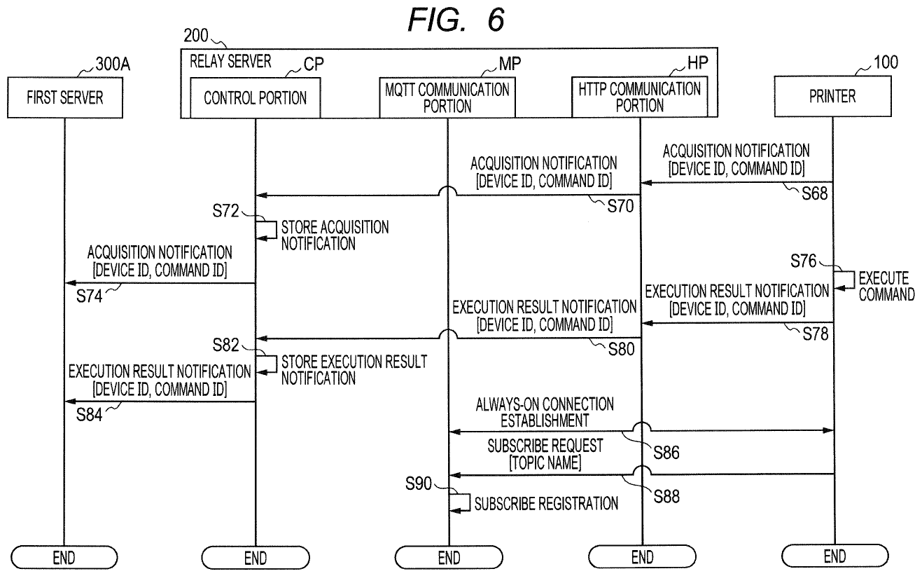

FIGS. 5 and 6 show an example of operations in a case where the printer 100 does not subscribe to a command when the relay server 200 accepts a command. For example, it is assumed, since the printer 100 is powered off, the printer 100 is in the offline state and the printer 100 does not subscribe to a command. In this state, in S51 of FIG. 5, the first server 300A transmits a command transmission instruction to the relay server 200. The command transmission instruction is transmitted in the same manner as in S16 of FIG. 3.

When the relay server 200 receives the command transmission instruction, in S52 the control portion CP of the relay server 200 registers (stores) the command information (FIG. 2) related to the command included in the command transmission instruction, similar to S18 of FIG. 3.

In S54, the control portion CP transmits an acceptance notification indicating that the command transmission instruction has been accepted to the first server 300A, similar to S20 of FIG. 3.

In S55, the control portion CP executes the storage command confirmation process, similar to S21 of FIG. 3. In S55, it is determined that no other command to be transmitted to the printer 100 is stored, similar to S21.

If it is determined that no other command to be transmitted is stored, in S56 the control portion CP passes a publish request to the MQTT communication portion MP, similar to S22 of FIG. 3.

When the MQTT communication portion MP receives the publish request, the MQTT communication portion MP attempts to transmit the command and command ID included in the publish request to the device that subscribes to the topic designated by the topic name included in the publish request. At this point, unlike the example in FIG. 3, since the printer 100 is not in a subscribed state, the MQTT communication portion MP does not store that the printer 100 subscribes to the topic addressed to the printer 100. Thus, the MQTT communication portion MP does not transmit the command and command ID to the printer 100. The MQTT communication portion MP does not notify the control portion CP that the command is not transmitted to the printer 100 due to the specifications of MQTT. Thus, the control portion CP does not recognize that the command has not been acquired by the printer 100.

After that, for example, the printer 100 transitions from an offline state to an online state, for example, due to the printer 100 being powered on. When the printer 100 transitions to the online state, in S58 the printer 100 transmits a storage command request to the relay server 200, similar to S2 in FIG. 3. As described above, the storage command request is transmitted as an HTTP request, and is received by the communication interface 280 of the relay server 200 and acquired by the HTTP communication portion HP of the relay server 200.

When the HTTP communication portion HP acquires the storage command request, in S60, the HTTP communication portion HP passes the storage command request to the control portion CP of the relay server 200, similar to S4 in FIG. 3. When the control portion CP receives the storage command request, in S62, the control portion CP executes a storage command confirmation process, similar to S6 in FIG. 4.

At this point, the command to be transmitted to the printer 100 based on the command transmission instruction received in S51 has not been transmitted to the printer 100. Thus, the status of the command is “accepted” and not “delivered”. Thus, the command information of the command is registered in the command information table CDT, and the command information is command information in the accepted state.

Thus, in the storage command confirmation process in S62, unlike S6 in FIG. 3, the control portion CP determines that a command to be transmitted to the printer 100 is stored.

If it is determined that a command to be transmitted is stored, in S64 the control portion CP passes a storage presence notification to the HTTP communication portion HP as data to be transmitted as a response. The storage presence notification indicates that a command to be transmitted is stored.

The storage presence notification includes the command to be transmitted to the printer 100 and information indicating the number of stored commands (storage commands). In the example of FIG. 5, since one command information in the accepted state is stored in the command information table CDT, the number of stored commands is 1. The number of stored commands is the number of commands to be transmitted to the printer 100 among the commands stored in the command information table CDT, in other words, the number of commands associated with status information indicating “accepted”.

When the HTTP communication portion HP receives the storage presence notification, in S66, the HTTP communication portion HP transmits the storage presence notification to the printer 100 as a response to the storage command request.

When the control portion CP passes the storage presence notification to the HTTP communication portion HP in S64, in S67 the control portion CP updates the status information of the command of the processing target from “accepted” to “delivered”. In this way, in S67, the status information is updated immediately at the time when the storage presence notification including the command is transmitted using the HTTP communication portion HP without receiving an acquisition notification from the printer 100.

When the printer 100 receives the storage presence notification, in the example of FIG. 5, the printer 100 receives one command. That is, the printer 100 receives the command using communication according to HTTP. In this case, too, the printer 100 transmits a command acquisition notification to the relay server 200 in the same way as when the printer 100 receives a command using communication according to MQTT (S23 in FIG. 3).

Specifically, in S68 of FIG. 6, the printer 100 transmits an acquisition notification to the relay server 200, similar to S25 of FIG. 4. The acquisition notification is transmitted to the relay server 200 as an HTTP request. Thus, the acquisition notification is received by the HTTP communication portion HP of the relay server 200.

Upon receiving the acquisition notification, in S70 the HTTP communication portion HP passes the acquisition notification to the control portion CP, similar to S26 of FIG. 4. At this point, the control portion CP recognizes that the command based on the command transmission instruction transmitted in S51 has been acquired by the printer 100.

Upon receiving the acquisition notification, in S72 the control portion CP stores the acquisition notification, similar to S27 of FIG. 4. For example, it is assumed that the command information of the command of the processing target is the command information CDb in FIG. 2. In this step, the first response information RDb1 is stored in the command information table CDT in association with the command information CDb.

In S74, the control portion CP transmits an acquisition notification to the first server 300A, similar to S30 in FIG. 4. In this way, the first server 300A recognizes that the command has been transmitted to the printer 100 and has been acquired by the printer 100 based on the command transmission instruction transmitted in S51.

After transmitting the acquisition notification in S68, the printer 100 executes the received command in S76, similar to S32 in FIG. 4. In S78, the printer 100 transmits an execution result notification indicating the execution result of the command to the relay server 200, similar to S34 in FIG. 4. Since the execution result notification is transmitted to the relay server 200 as an HTTP request, the execution result notification is received by the HTTP communication portion HP of the relay server 200.

When the HTTP communication portion HP receives the execution result notification, in S80 the HTTP communication portion HP passes the execution result notification to the control portion CP. When the control portion CP receives the execution result notification, in S82 the control portion CP stores the execution result notification. For example, the second response information RDb2 is stored in the command information table CDT in FIG. 2 in association with the command information CDb.

In S84, the control portion CP transmits the execution result notification received in S80 to the first server 300A. In this way, the first server 300A recognizes the execution result of the command transmitted based on the command transmission instruction transmitted in S51.

When the printer 100 receives all commands addressed to the printer 100 stored in the relay server 200, in S86 the printer 100 establishes an always-on connection with the MQTT communication portion MP of the relay server 200, similar to S10 in FIG. 3.

When the printer 100 establishes an always-on connection, in S88, the printer 100 transmits a subscribe request to the MQTT communication portion MP, similar to S12 in FIG. 3. When the MQTT communication portion MP receives the subscribe request, in S90, the MQTT communication portion MP executes a subscribe registration, similar to S14 in FIG. 3. In this way, the printer 100 becomes a subscribed state. After this, when the server 300A or 300B transmits, to the relay server 200, an instruction to transmit a command addressed to the printer 100, the process described in S16 in FIG. 3 to S40 in FIG. 4 is executed.

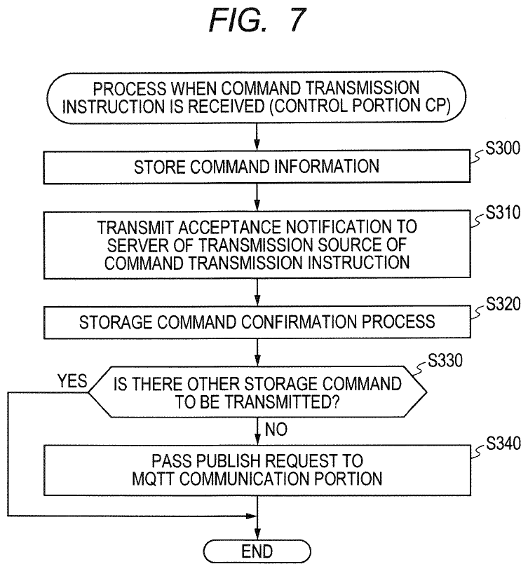

The above describes the operation of the system 1000. With reference to FIG. 7, a supplementary explanation will be given for a process in a case where the control portion CP of the relay server 200 receives a command transmission instruction (S16 in FIG. 3) from the server 300A or 300B. FIG. 7 is a flowchart of the process when a command transmission instruction is received.

For example, as shown in S16 of FIG. 3 and S51 of FIG. 5, when the control portion CP of the relay server 200 receives a command transmission instruction from the server 300A or 300B, in S300 the control portion CP stores the command information in the command information table CDT. In S310, the control portion CP transmits an acceptance notification to the server (for example, the first server 300A) that has transmitted the command transmission instruction. S300 corresponds to the process of S18 of FIG. 3 and S52 of FIG. 5, and S310 corresponds to the process of S20 of FIG. 3 and S54 of FIG. 5.

In S320, the control portion CP executes a storage command confirmation process. As explained in S21 of FIG. 3 and S55 of FIG. 5, S320 is a process of determining whether another command to be transmitted to the printer 100 is stored. As shown in S330, if the control portion CP determines in the storage command confirmation process that no other command to be transmitted is stored (S330: NO), in S340, the control portion CP passes a publish request for the command (also called a target command) based on the received command transmission instruction to the MQTT communication portion MP. S340 corresponds to the process of S22 in FIG. 3 and S56 in FIG. 5.

If the control portion CP determines in the storage command confirmation process that another command to be transmitted is stored (S330: YES), the process of S340 is skipped. That is, if the control portion CP determines that another command to be transmitted is stored (S330: YES), the control portion CP does not pass a publish request for the target command to the MQTT communication portion MP.

As described above, in a case where no other command to be transmitted to the printer 100 is stored and the printer 100 is in a subscribed state, the target command is immediately transmitted from the MQTT communication portion MP to the printer 100, as shown in S23 in FIG. 3. In a case where another command to be transmitted to the printer 100 is stored, the target command is not transmitted from the MQTT communication portion MP to the printer 100 even if the printer 100 is in a subscribed state.

The reason for this will be explained. It is assumed that, even if another command to be transmitted to the printer 100 is stored, the control portion CP passes a publish request to the MQTT communication portion MP, and the target command is immediately transmitted from the MQTT communication portion MP to the printer 100. In this case, the target command is transmitted to the printer 100 even though the other command to be transmitted has not been transmitted to the printer 100. In this case, the transmission instruction for the other command is received before the target command, but the other command is transmitted to the printer 100 after the target command. In other words, the transmission order of the commands becomes different from the reception order of the transmission instruction for the commands. In this case, in a case where the execution order of the commands in the printer 100 is significant, it may not be possible to cause the printer 100 to execute the desired operation. For example, when page 2 is to be printed after page 1, an inconvenience occurs in which page 2 is printed before page 1.

In the present embodiment, in order to prevent such inconvenience, in a case where another command to be transmitted is stored, the target command is not transmitted from the MQTT communication portion MP, and the target command is stored together with the other command. The other stored command and the target command are transmitted to the printer 100 by the HTTP communication portion HP. As described below, in a case where a plurality of commands are stored, the HTTP communication portion HP transmits the commands to the printer 100 in the order of acceptance of the command transmission instructions, thereby preventing the above-mentioned inconvenience.

In FIG. 3, a case was described in which no command to be transmitted is stored in the relay server 200 when a storage command request is transmitted from the printer 100 to the HTTP communication portion HP of the relay server 200 (S2 to S9 in FIG. 3). In FIGS. 5 and 6, a case was described in which one command to be transmitted is stored in the relay server 200 when the storage command request is transmitted from the printer 100 to the HTTP communication portion HP (S58 in FIG. 5 to S84 in FIG. 6).

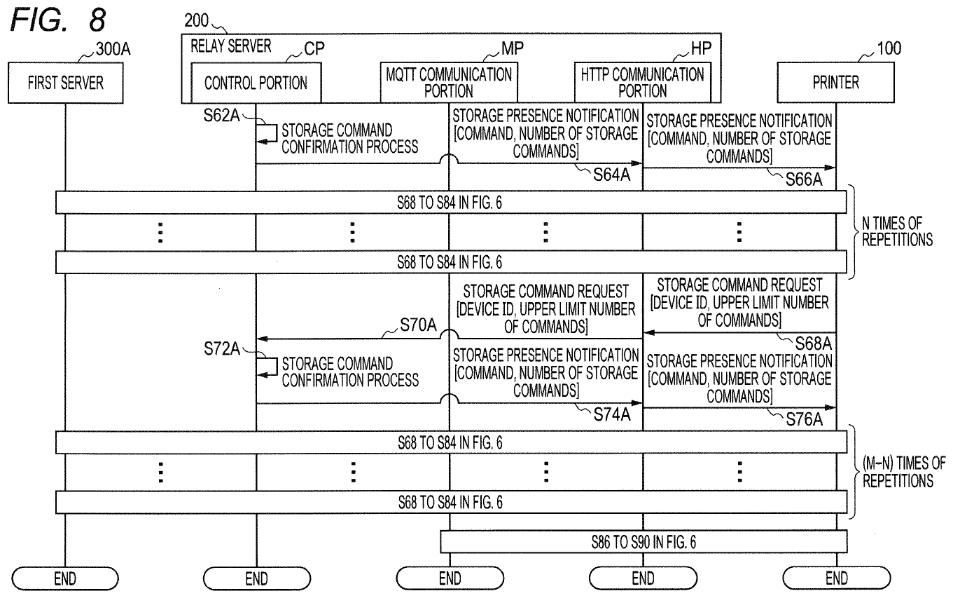

With reference to FIG. 8, a case will be described in which M commands to be transmitted are stored in the relay server 200 when the storage command request is transmitted from the printer 100 to the HTTP communication portion HP (S58 in FIG. 5) and the storage command request is passed to the control portion CP (S60 in FIG. 5). In this case, in S62A in FIG. 8, the control portion CP executes the storage command confirmation process as in S62 in FIG. 5, but determines in the storage command confirmation process that a plurality of commands to be transmitted are stored. The number of stored commands is M. When the upper limit number of commands is N (N is an integer of 1 or more), M is a number greater than N and less than twice N (N<M<2N). The number of commands that can be included in one storage presence notification is limited to N or less.

In S64A, the control portion CP passes the storage presence notification to the HTTP communication portion HP. Specifically, the control portion CP determines the acceptance order of the M commands, in other words, the storage order of the M command information in the command information table CDT, based on the reception date and time of the M commands to be transmitted. The control portion CP identifies N commands based on the order in which the M commands were stored. The control portion CP generates a storage presence notification that includes the N commands. In the storage presence notification, the N commands are arranged according to the storage order. As a result, when the storage presence notification is transmitted from the relay server 200 to the printer 100 in S66A described later, the N commands are transmitted to the printer 100 in the order in which the N commands were stored. The storage presence notification further includes information indicating the number M of stored commands.

When the HTTP communication portion HP receives the storage presence notification, in S66A, the HTTP communication portion HP transmits the storage presence notification to the printer 100 as a response to the storage command request.

By receiving the storage presence notification, the printer 100 acquires the N commands in the order in which the commands are stored. When the printer 100 acquires the N commands, the process of S68 to S84 in FIG. 6 is executed for each of the N commands. That is, the process of S68 to S84 in FIG. 6 is executed N times. The process of S68 to S84 in FIG. 6 for each command is executed in the order in which the commands were stored.

Since the storage presence notification received by the printer 100 includes information indicating the number M of stored commands, the printer 100 recognizes that in addition to the acquired N commands, there are (M-N) commands that have not been acquired yet on the relay server 200. Thus, after repeating the process of S68 to S84 in FIG. 6 N times, in S68A the printer 100 transmits a storage command request to the relay server 200 to acquire the (M-N) commands that have not been acquired. The request is acquired by the HTTP communication portion HP of the relay server 200.

When the HTTP communication portion HP acquires the storage command request, in S70A the HTTP communication portion HP passes the storage command request to the control portion CP of the relay server 200. When the control portion CP receives the storage command request, in S72A the control portion CP executes a storage command confirmation process similar to S62A. In the storage command confirmation process, it is determined that the remaining (M-N) commands to be transmitted are stored.

In S74A, the control portion CP generates a storage presence notification including the remaining (M-N) commands, and passes the storage presence notification to the HTTP communication portion HP. In the storage presence notification, the (M-N) commands are arranged in the order in which the (M-N) commands were stored. The storage presence notification further includes information indicating the number of stored commands (M-N).

When the HTTP communication portion HP receives the storage presence notification, in S76A the HTTP communication portion HP transmits the storage presence notification to the printer 100 as a response to the storage command request.

By receiving the storage presence notification, the printer 100 acquires the remaining (M-N) commands in the order in which the (M-N) commands were stored. Next, the process of S68 to S84 in FIG. 6 is executed for each of the (M-N) commands. That is, the process of S68 to S84 in FIG. 6 is executed repeatedly (M-N) times. The process of S68 to S84 in FIG. 6 for each command is executed in the order in which the commands were stored.

Since the storage presence notification received by the printer 100 includes information indicating the number of stored commands (M-N), the printer 100 recognizes that there is no command that has not been acquired yet on the relay server 200. Thus, after repeating the process of S68 to S84 in FIG. 6 (M-N) times, the printer 100 executes S86 to S90 in FIG. 6 to subscribe to the command addressed to the printer 100. As described above, when a plurality of commands are stored in the relay server 200, the relay server 200 transmits the commands to the printer 100 so that the printer 100 acquires the plurality of commands in the same order as the order in which the commands were stored (the order in which the command transmission instructions were accepted).

According to the embodiment described above, the control portion CP of the relay server 200 stores the commands in the management database DBm in association with status information (S18 in FIG. 3 and S52 in FIG. 5). The MQTT communication portion MP of the relay server 200 transmits a command to the printer 100 according to MQTT, which is a push-type communication method (S22 and S23 in FIG. 3). The HTTP communication portion HP of the relay server 200 transmits a command associated with status information indicating “accepted”, among the commands stored in the management database DBm, to the printer 100 according to HTTP, which is a pull-type communication method (S66 in FIG. 5). After transmitting a command to the printer 100 using the MQTT communication portion MP (S22 and S23 in FIG. 3), when the control portion CP receives an acquisition notification regarding the command transmitted from the printer 100 (S25 and S26 in FIG. 4), the control portion CP updates the status information of the command from information indicating “accepted” to information indicating “delivered” (S28 in FIG. 4). When the control portion CP receives the storage command request transmitted from the printer 100 (S58 and S60 in FIG. 5), the control portion CP uses the HTTP communication portion HP to transmit, to the printer 100, a command associated with the status information indicating “accepted” (that is, a command that has not yet been delivered to the printer 100) (S64 and S66 in FIG. 5).

That is, in the above embodiment, after transmitting a command to the printer 100 using the MQTT communication portion MP, when receiving an acquisition notification from the printer 100, the status of the command is updated from “accepted” to “delivered”. When receiving a storage command request from the printer 100, the HTTP communication portion HP is used to transmit the command in the accepted state to the printer 100. Thus, in a case where the transmission of the command by the MQTT communication portion MP fails, the acquisition notification from the printer 100 is not received, and thus the HTTP communication portion HP transmits the command to the printer 100 in response to the storage command request from the printer 100. Thus, while using MQTT for communication with the printer 100, the reliability of the transmission of commands to the printer 100 is improved.

This will be described in more detail. In the MQTT specifications, in a case where the control portion CP passes a publish request to the MQTT communication portion MP but the printer 100 is not in a subscribed state at that time, the MQTT communication portion MP does not transmit the command to the printer 100. In a case where the MQTT communication portion MP transmits a command to the printer 100 in a subscribed state and the communication interface 180 of the printer 100 receives the command but the application AP has a problem at that time or the load of the application AP is high, the application AP may not be able to acquire the command properly. In such a case, in order to transmit the command to the printer 100, it is considered that the relay server 200 transmits the command to the printer 100 again.

However, in the MQTT specification, the MQTT communication portion MP does not return a response of the communication result to the control portion CP in response to the publish request. Thus, the control portion CP does not recognize whether the MQTT communication portion MP has transmitted a command to the printer 100 or whether the printer 100 (application AP) has acquired the command properly by communication according to MQTT.

Since communication according to MQTT is a push-type communication, delays in command transmission are less likely to occur compared to pull-type communication (such as HTTP). For example, in order to shorten the delay in pull-type communication, the printer 100 needs to perform polling at short intervals, and the control portion CP of the relay server 200 also needs to support this polling. This may result in excessive load on the printer 100 and the control portion CP of the relay server 200.

In the present embodiment, when the printer 100 receives a command properly, the printer 100 transmits an acquisition notification to the control portion CP (S25 and S26 in FIG. 4). When the control portion CP receives the acquisition notification, the control portion CP updates the status of the command to “delivered” (S27 in FIG. 4), so that the control portion CP of the relay server 200 recognizes whether the command has been acquired by the printer 100 based on the status information of the command. When receiving a storage command request from the printer 100, the HTTP communication portion HP (that is, using communication according to HTTP) transmits, to the printer 100, a command associated with the status information indicating “accepted” (that is, a command that has not been transmitted to the printer 100) in response to the storage command request (S64 and S66 in FIG. 5). As a result, for example, a command that was not transmitted to the printer 100 in communication according to MQTT is transmitted to the printer 100 in communication according to HTTP.

Communication according to HTTP is a pull-type communication that transmits a response in response to a request from the printer 100. Thus, by using communication according to HTTP, a command is more reliably transmitted to the printer 100 when the printer 100 is ready to acquire the command. As described above, the command is reliably transmitted to the printer 100 by using communication according to HTTP while having the advantages of MQTT, which transmits commands with low load and low delay.

By receiving the acquisition notification, the command in the delivered state will not be transmitted to the printer 100 by the HTTP communication portion HP. Thus, the command is prevented from being transmitted to the printer 100 in duplicate.

According to the present embodiment, after the control portion CP transmits the command to the printer 100 using the HTTP communication portion HP in response to the storage command request, the control portion CP updates the status information of the command from “accepted” to “delivered” without receiving the acquisition notification (S67 in FIG. 5).

In a case where the command is transmitted to the printer 100 by the pull-type communication (in other words, in response to the request of the printer 100), since the printer 100 is considered to be ready to receive the command, the possibility that the command transmission fails is low. Thus, in this case, the status information is updated promptly without waiting for the acquisition notification.

According to the present embodiment, the “accepted” state is a state in which a command has not been acquired by the application AP that processes the command. Specifically, this includes a state where the command has not been transmitted from the MQTT communication portion MP to the printer 100, and a state where the command has been transmitted from the MQTT communication portion MP to the communication interface 180 of the printer 100 but the application AP has not acquired the command from the reception buffer. As a result, the HTTP communication portion HP transmits a command in the accepted state to the printer 100, so that the application AP of the printer 100 acquires the command reliably.

According to the present embodiment, the command information table CDT of the management database DBm is configured to store a plurality of command information. That is, the relay server 200 is configured to store a plurality of commands. The control portion CP notifies the printer 100 about the number of stored commands by including the number of stored commands in the storage presence notification (S64 and S66 in FIG. 5). As a result, the printer 100 recognizes the number of commands to be received from the relay server 200. As a result, the device more reliably acquires all commands to be received. For example, in the example of FIG. 8, since the printer 100 recognizes that the printer 100 should acquire M commands, in S68A, the printer 100 transmits a second storage command request to the relay server 200, thereby acquiring all of the commands to be acquired.

According to the present embodiment, the storage command request includes information (information indicating the upper limit number of commands) that specifies the number of commands that can be received in one response (S58 in FIG. 5 and so on). In response to the storage command request, the control portion CP transmits a response (specifically, a storage presence notification) that includes commands up to the upper limit number of commands to the printer 100 using the HTTP communication portion HP (S56A, S66A, and so on in FIG. 8). The number of commands that can be acquired at one time is limited by, for example, the size of the resources of the printer 100 (for example, the capacity of the reception buffer). In the present embodiment, the number of commands that can be included in one storage presence notification is set to be equal to or less than the upper limit number of commands notified by the printer 100, thereby suppressing the inconvenience of the printer 100 being unable to acquire all of the commands due to a lack of resources. Thus, the printer 100 more reliably acquires the commands that should be acquired.

According to the present embodiment, the MQTT communication portion MP maintains communication with the printer 100 by establishing an always-on connection according to MQTT (S10 in FIG. 3 and S86 in FIG. 6). When the printer 100 is in a subscribed state, in other words, when communication with the printer 100 is maintained, the MQTT communication portion MP receives a transmission instruction (specifically, a publish request) from the control portion CP (S22 in FIG. 3), and transmits data (for example, a command) based on the publish request to the printer 100 (S23 in FIG. 3). When communication with the printer 100 is not maintained, the MQTT communication portion MP does not transmit data based on the publish request to the printer 100 when the MQTT communication portion MP receives a publish request from the control portion CP (S56 in FIG. 5). When the HTTP communication portion HP receives an HTTP request (for example, a storage command request) from the printer 100 (for example, S2 in FIG. 3 and S58 in FIG. 5), the HTTP communication portion HP transmits an HTTP response (storage absence notification or storage presence notification) to the printer 100 based on a transmission instruction from the control portion CP (S9 in FIG. 3 and S66 in FIG. 5).

As can be seen from this configuration, in MQTT communication, even if the control portion CP makes a publish request, if communication with the printer 100 is not maintained, such as when the printer 100 is in the offline state, the command is not transmitted to the printer 100. Thus, there is a reasonable possibility that transmission of a command using MQTT will fail. In HTTP, since the printer 100 is considered to be ready to receive commands when the printer 100 transmits an HTTP request, the possibility that command transmission fails is low. According to the present embodiment, even if transmission of a command by MQTT fails, since the command is transmitted by HTTP in response to an HTTP request from the printer 100, the reliability of transmission of the command to the device is improved.

According to the present embodiment, when the printer 100 becomes the online state, the printer 100 transmits a storage command request to the relay server 200. As a result, when the printer 100 becomes the online state, the relay server 200 transmits the command in the accepted state (that is, the command to be transmitted to the printer 100) to the printer 100 in the order of storage in the command information table CDT, starting with the command that was stored first using the HTTP communication portion HP (FIG. 8). As a result, even if transmission of a plurality of commands by MQTT fails because the device was in the offline state, the commands are transmitted to the printer 100 in the correct order by HTTP when the printer 100 becomes the online state.

According to the present embodiment, when the control portion CP of the relay server 200 receives a first command to be transmitted to the printer 100 from the first server 300A (S16 in FIG. 3), as shown in FIG. 7, the control portion CP stores the first command in the command information table CDT in association with the status information indicating “accepted” and reception date and time information to identify the order of storage in the command information table CDT (S300 in FIG. 7). The control portion CP further executes a storage command confirmation process (S320 in FIG. 7) to determine whether another command to be transmitted is stored. That is, the control portion CP determines whether the command information table CDT stores a second command that is stored before the first command and that is associated with the status information indicating “accepted”.

When the second command is not stored in the command information table CDT (NO in S330 in FIG. 7), the control portion CP uses the MQTT communication portion MP to transmit the first command to the printer 100 (S340 in FIG. 7 and S22 and S23 in FIG. 3). When the second command is stored in the command information table CDT (YES in S330 of FIG. 7), the control portion CP does not use the MQTT communication portion MP to transmit the first command to the printer 100. As a result, in this case, the first command and the second command are stored in the relay server 200.

In response to the storage command request, the control portion CP uses the HTTP communication portion HP to transmit the second command to the printer 100 in the order of storage, and then uses the HTTP communication portion HP to transmit the first command to the printer 100 (FIG. 8).

In this way, while commands are stored in the relay server 200, the relay server 200 transmits commands to the printer 100 using the HTTP communication portion HP, and does not transmit commands to the printer 100 using the MQTT communication portion MP. In a case where a new command transmission instruction is received when no command is stored in the relay server 200, the relay server 200 transmits the command to the printer 100 using the MQTT communication portion MP. This enables the relay server 200 to transmit commands to the printer 100 in the order in which the command transmission instructions are received.

According to the present embodiment, the MQTT communication portion MP of the relay server 200 receives a reception notification indicating that the target data has been received according to MQTT (S24 in FIG. 3). This reception notification is different from the acquisition notification (S25 and S26 in FIG. 4) received by the HTTP communication portion HP and passed to the control portion CP. The control portion CP does not update the status of the command from “accepted” to “delivered” when the MQTT communication portion MP receives the reception notification and updates the status of the command from “accepted” to “delivered” when the HTTP communication portion HP receives the acquisition notification (S28 in FIG. 4). For example, when a reception notification is received, it can be confirmed that the function of the printer 100 as an MQTT client has received the command, but this does not necessarily mean that the application that processes the command of the printer 100 has acquired the command. When the acquisition notification transmitted according to HTTP, which is a protocol different from MQTT, is received, it is considered that an application that processes upper-level commands than the MQTT client inside the printer 100 has received the command and transmitted the acquisition notification using the function as an HTTP client. Thus, when the acquisition notification transmitted according to HTTP is received, that is, when there is a high possibility that the application that processes the command in the printer 100 has received the command, the status of the command is updated. Thus, the application that processes the command more reliably acquires the command.

As can be seen from the above description, the accepted state of the present embodiment is an example of a first state, and the delivered or cancelled state is an example of a second state. The acquisition notification of the present embodiment is an example of a particular notification, and the storage command request is an example of a particular request. The servers 300A and 300B of the present embodiment are examples of an external device, and the command is an example of target data. The MQTT communication portion MP is an example of a communication maintenance portion, a first transmission portion, and a first reception portion, and the HTTP communication portion HP is an example of a first transmission portion and a second reception portion.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

(1) In the above embodiment, the printer 100 transmits two responses, that is, the acquisition notification and the execution result notification, to the relay server 200 (the HTTP communication portion HP) for one command. However, the printer 100 may transmit one response to the relay server 200. For example, in a case where the command is a print instruction, it takes a certain amount of time for the printer 100 to execute printing. Thus, in this case, as in the embodiment, the acquisition notification is transmitted to the relay server 200 at the stage of receiving the command, and the execution result notification is transmitted to the relay server 200 at the stage of completing the printing. For example, in a case where the command is an instruction to transmit the remaining amount of ink, the printer 100 just reads the remaining amount of ink from the memory and transmits the remaining amount of ink, and thus the time required to execute the command is short. Thus, in this case, the printer 100 may read the remaining ink amount immediately after receiving the command and transmit the execution result notification including the remaining ink amount to the relay server 200. In this case, the acquisition notification is not transmitted to the relay server 200. Depending on the type of command, three or more responses may be transmitted to the relay server 200 in response to one command.

Regardless of the number of responses to one command, the control portion CP of the relay server 200 may update the status information of the command from “accepted” to “delivered” when receiving the first response among one or more responses to one command.

(2) In the above embodiment, the status of a command may take three states, that is, accepted, delivered, and cancelled. The number of states that the status of the command may take is not limited to this, and may be two, or may be four or more. For example, in a case where the mechanism for cancelling the command is not provided, the status of the command may be two types, that is, “accepted” and “delivered”. For example, the relay server 200 may have a mechanism that determines whether the printer 100 is in the online state or the offline state when the relay server 200 receives a command transmission instruction from the first server 300A, and rejects acceptance of the command transmission instruction when the printer 100 is in the offline state. In this case, the status of the command may include a state of “acceptance rejected” in addition to the three types in the embodiment.

(3) In the above embodiment, when the control portion CP transmits a command to the printer 100 using the HTTP communication portion HP, as shown in S67 of FIG. 5, the control portion CP updates the status of the command from “accepted” to “delivered” without receiving an acquisition notification from the printer 100. Alternatively, even in a case where the command is transmitted to the printer 100 using the HTTP communication portion HP, the control portion CP may update the status of the command from “accepted” to “delivered” after receiving the acquisition notification from the printer 100, similarly to a case where the command is transmitted using the MQTT communication portion MP.

(4) The control portion CP of the relay server 200 includes information indicating the number of commands stored in the relay server 200 (the number of stored commands) in the storage presence notification to be transmitted to the printer 100, but the number of stored commands may not be included in the storage presence notification. In this case, for example, in order to receive all the commands stored in the relay server 200, when the printer 100 receives the storage presence notification, the printer 100 processes commands included in the storage presence notification and then transmits a storage command request to the relay server 200. When the printer 100 receives a storage absence notification as a response to the storage command request, the printer 100 does not transmit the storage command request to the relay server 200.

(5) The control portion CP of the relay server 200 includes the information indicating the upper limit number of commands in the storage presence notification to be transmitted to the printer 100, but the information indicating the upper limit number of commands may not be included in the storage presence notification. In this case, for example, the upper limit number of commands may be set to a predetermined number, for example, a number (for example, one) that is surely received by the printer 100 in one response.

(6) In the above embodiment, a communication method according to MQTT is adopted as the first communication method, but another push-type communication method may be adopted. Further, although the communication method according to HTTP is adopted as the second communication method, another pull-type communication method may be adopted. As the first communication method, for example, XMPP (eXtensible Messaging and Presence Protocol) may be adopted. As the second communication method, for example, an FTP (File Transfer Protocol) may be adopted.

(7) In the above embodiment, information indicating the reception date and time is used as information for specifying the storage order of commands in the command information table CDT, in other words, information for specifying the acceptance order of commands. Alternatively, the information for specifying the acceptance order of commands may be other information, for example, numbers assigned to the commands in ascending order according to the acceptance order of the commands. The numbers assigned in ascending order may also serve as command IDs, for example.

(8) In the above embodiment, the printer 100 is used as a device used for providing a service, but other types of devices may be employed. The device may be, for example, a scanner or a digital camera that generates image data by optically reading an object using an image sensor. The device may be, for example, a sewing machine that forms an image such as a pattern on a fabric by embroidering the fabric with a thread, or a terminal device such as a smartphone or a personal computer.

Further, the device is not limited to an image processing apparatus such as a printer, a scanner, a camera, or a sewing machine, and various devices configured to be connectable to the Internet IT may be employed. For example, the device may be a device unrelated to an image, for example, a household electrical appliance such as a refrigerator or a microwave oven, or may be a music player or a temperature sensor.

The services provided by the servers 300A, 300B may be a variety of services depending on the device employed. As the service, for example, a service that is realized by remotely operating a device by transmitting a command to the device or a service that is realized by collecting information regarding the device from the device by transmitting a command to the device may be adopted.

The target data transmitted from the servers 300A and 300B to the device via the relay server 200 is not limited to a command. The target data may be data for providing a notification or information to a user of the device, or may be data such as setting information to be stored in the device.

(9) In the above embodiment, the acquisition notification and the execution result notification are transmitted as HTTP requests from the printer 100 to the HTTP communication portion HP of the relay server 200. Alternatively, the acquisition notification may be transmitted from the printer 100 to the MQTT communication portion MP by using the MQTT. In this case, for example, a topic name addressed to the control portion CP is set from the printer 100 and registered in the MQTT communication portion MP. The control portion CP always subscribes by designating the topic name. The printer 100 transmits the acquisition notification or the execution result notification to the MQTT communication portion MP as a publish request by designating the topic name. In this way, the printer 100 allows the control portion CP of the relay server 200 to acquire the acquisition notification and the execution result notification at an arbitrary timing.

(10) In the above embodiment, in response to receiving the acquisition notification of the command transmitted from the MQTT communication portion MP, the control portion CP of the relay server 200 always updates the status information of the command (S28 in FIG. 4). Alternatively, the printer 100 may add, to the acquisition notification, flag information indicating whether to update the status information. The control portion CP may update the status information of the command when the acquisition notification includes the flag information indicating that the status information is to be updated, and may not update the status information of the command when the acquisition notification includes the flag information indicating that the status information is not to be updated. In this case, for example, when the printer 100 receives a command at the time of a high load, the printer 100 adds, to the acquisition notification, the flag information indicating that the status information is not to be updated, so that the printer 100 receives the command again later.

(11) In the above-described embodiment, a part of the configuration realized by hardware may be replaced by software, and conversely, a part or all of the configuration realized by software may be replaced by hardware.

What is claimed is:

1. A server comprising:
a communication interface;
a memory configured to store target data in association with status information, the status information indicating a plurality of states including a first state and a second state, the first state indicating that the target data is to be transmitted to a device of a transmission destination, the second state being different from the first state; and
a controller configured to:
transmit, via the communication interface, the target data to the device by a first communication method, the first communication method being a push-type communication method;
after transmitting the target data to the device, receive, via the communication interface, a particular notification relating to the target data from the device;
in response to receiving the particular notification, update the status information of the target data from information indicating the first state to information indicating the second state;
receive, via the communication interface, a particular request from the device; and
in response to receiving the particular request, transmit, to the device, the target data associated with the status information indicating the first state by a second communication method, the second communication method being a pull-type communication method.

2. The server according to claim 1, wherein the controller is configured to:
after transmitting the target data to the device by the second communication method in response to the particular request, update the status information of the target data from information indicating the first state to information indicating the second state, without receiving the particular notification.

3. The server according to claim 1, wherein the first state includes a state in which the target data is not acquired by a particular application that processes the target data in the device.

4. The server according to claim 1, wherein the memory is configured to store a plurality of target data; and
wherein the controller is configured to:
in response to receiving the particular request, transmit, to the device, a number of target data associated with the status information indicating the first state, among the plurality of target data stored in the memory.

5. The server according to claim 1, wherein the particular request includes number information specifying a number of target data that are receivable in one response; and
wherein the controller is configured to:
in response to receiving the particular request, transmit, to the device, a response including a number of target data less than or equal to the number specified by the number information by the second communication method.

6. The server according to claim 1, wherein the controller is configured to:
establish communication with the device by the first communication method;
in response to receiving a transmission instruction when the communication with the device by the first communication method is maintained, transmit data based on the transmission instruction to the device;
in response to receiving a transmission instruction when the communication with the device by the first communication method is not maintained, not transmit data based on the transmission instruction to the device; and
in response to receiving a request from the device by the second communication method, transmit, to the device, data based on the transmission instruction as a response to the request by the second communication method.

7. The server according to claim 6, wherein the first communication method is a communication method in accordance with MQTT (Message Queueing Telemetry Transport); and
wherein the second communication method is a communication method in accordance with HTTP (HyperText Transfer Protocol).

8. The server according to claim 1, wherein the controller is configured to:
when the server becomes ready to communicate with the device and the particular request is received from the device, transmit, to the device, one or more target data associated with the status information indicating the first state sequentially in a storage order by the second communication method, the storage order being an order in which the one or more target data is stored in the memory.

9. The server according to claim 1, wherein the controller is configured to:
receive, from an external device, first target data to be transmitted to the device;
store the first target data in the memory in association with the status information indicating the first state and information for specifying a storage order in the memory;
determine whether the memory stores one or more second target data that is stored before the first target data and that is associated with the status information indicating the first state;
in response to determining that the memory does not store the one or more second target data, transmit the first target data to the device by the first communication method; and
in response to determining that the memory stores the one or more second target data, not transmit the first target data to the device by the first communication method and transmit the one or more second target data sequentially in the storage order in response to the particular request by the second communication method, and then transmit the first target data to the device by the second communication method.

10. The server according to claim 1, wherein the controller is configured to:
receive an other notification by the first communication method, the other notification indicating that the target data has been received, the other notification being different from the particular notification;
receive the particular notification by the second communication method;
in response to receiving the other notification, not update the status information of the target data from information indicating the first state to information indicating the second state; and
in response to receiving the particular notification, update the status information of the target data from information indicating the first state to information indicating the second state.

11. The server according to claim 1, wherein the controller is configured to:
receive the particular notification from the device by the second communication method; and
receive the particular request from the device by the second communication method.

12. The server according to claim 1, wherein the controller is configured to:
receive a command transmission instruction from an external device, the command transmission instruction including the target data and a target device ID, the target device ID being a device ID of the device of the transmission destination; and
in response to receiving the command transmission instruction, store command information in the memory, the command information including the target data, the target device ID, a reception date and time of the target data, and the status information indicating the first state.

13. The server according to claim 1, wherein the target data is a command to be executed by a particular application of the device; and
wherein the particular notification is an acquisition notification indicating that the particular application has acquired the command.

14. A communication system comprising a server and a device,
the server comprising:
a server communication interface configured to connect to the device via a network;
a server controller; and
a memory configured to store target data in association with status information, the status information indicating a plurality of states including a first state and a second state, the first state indicating that the target data is to be transmitted to the device of a transmission destination, the second state being different from the first state,
the device comprising;
a device communication interface configured to connect to the server via the network; and
a device controller,
the server controller configured to:
transmit, via the server communication interface, the target data to the device by a first communication method, the first communication method being a push-type communication method;
the device controller configured to:
after receiving the target data from the server, transmit, via the device communication interface, a particular notification relating to the target data to the server;
the server controller configured to:
receive, via the server communication interface, the particular notification from the device;
in response to receiving the particular notification, update the status information of the target data from information indicating the first state to information indicating the second state;
the device controller configured to:
transmit, via the device communication interface, a particular request for acquiring the target data to the server;
the server controller configured to:
receive, via the server communication interface, the particular request from the device; and
in response to receiving the particular request, transmit, to the device, the target data associated with the status information indicating the first state by a second communication method, the second communication method being a pull-type communication method.

15. A method of transmitting target data to a device, the method comprising:
storing target data in a memory in association with status information, the status information indicating a plurality of states including a first state and a second state, the first state indicating that the target data is to be transmitted to a device of a transmission destination, the second state being different from the first state;
transmitting, via a communication interface, the target data to the device by a first communication method, the first communication method being a push-type communication method;
after transmitting the target data to the device, receiving, via the communication interface, a particular notification relating to the target data from the device;
in response to receiving the particular notification, updating the status information of the target data from information indicating the first state to information indicating the second state;
receiving, via the communication interface, a particular request from the device; and
in response to receiving the particular request, transmitting, to the device, the target data associated with the status information indicating the first state by a second communication method, the second communication method being a pull-type communication method.
